(19) United States
(12) Patent Application Publication
(10) Pub. No.: US 2007/0140802 A1
(43) Pub. Date: Jun. 21, 2007

(54) Rotary cutting tool for intermittent cutting through metal

(76) Inventor: Andy Locke, Thunder Bay (CA)

Correspondence Address: Ade & Company Inc., 1795 Henderson Highway, P.O. Box 28006, Winnipeg, MB, R2G 4E9, US

(21) Appl. No.: 11/521,390

(22) Filed: Sep. 15, 2006

Related U.S. Application Data
(60) Provisional application No. 60/751,647, filed on Dec. 20, 2005.

(51) Int. Cl. B23B 51/04

(52) U.S. Cl. 408/204

(57) ABSTRACT

A rotary cutting tool fed along its axis of rotation is used for cutting processes in which teeth of the tool do not continuously engage a workpiece, such as forming a cope. A cylindrical body of the tool is fluteless in order to keep the tool's cutting swath to a minimum thickness and thus reduce the cutting forces and heat generation from those of conventional annular metal cutters. Circumferential spacing of teeth about an annular end face of the body acts to contain material removed from the workpiece until reaching a portion of the tool's rotational path in which the workpiece is not engaged, at which point the material is freed from the tool to prevent jamming. An outer surface of the cylindrical body is continuous over a substantial majority of its length in order to ensure adequate tool strength.

This application claims the benefit under 35 U.S.C. 119(e) of U.S. provisional application Ser. No. 60/751,647, filed Dec. 20, 2005.

### FIELD OF THE INVENTION

This invention relates to a rotary cutting tool fed in a direction parallel to its axis of rotation, and more particularly to an axially fed rotary tool for metal cutting where the tool engages the workpiece during only a portion of its rotation.

### BACKGROUND OF THE INVENTION

In manufacturing it is often necessary to shape a portion of one structural member to conform to the shape of another in order to facilitate a junction between the two. This process is known as providing the member with a cope. For example, hollow metal sections are often coped to facilitate welding to members having curved surfaces, such as pipe. One conventional method of forming such a cope involves flame cutting a rough approximation of the cope by hand and then grinding the coped area until it fits well enough to allow welding. Obtaining the necessary accuracy by hand is a very time intensive process which can significantly slow down production. CNC flame cutting machines can cope more accurately than a person can by hand, but finish grinding is sill required to complete the process and the high initial cost of such a machine may eliminate it as a feasible option.

Creating the curved form of a cope suggests that the use of a rotational cutting tool may provide faster results than the combination of flame cutting and grinding by hand. However, conventional rotary tools for making circular cuts are not well suited for performing the task of creating a cope.

Conventional annular metal cutters are fluted to allow cuttings to exit the cutting area. To allow for a flute, the cutter bodies and subsequently the swath of material being removed are quite wide. A wide cut results in a high degree of loading on the tool which generates a correspondingly high amount of heat and tool wear. These cutters are usually produced to have a relatively small shank diameter and a high degree of hardness throughout the tool. While suitable for cutting processes where all of the teeth of the tool are in constant contact with a workpiece, these annular cutters are not suitable for cuts where the teeth are only intermittently cutting material, as when forming a cope. The hardness of the tool body makes it brittle, which in combination with the wide swath of cut and excessive torque exerted on a small shank, may lead to shattering of the tool during such intermittent cuts.

Conventional hole saws, having a high number of teeth in a tightly spaced arrangement about the cutting end of the tool body and often driven by drill motors for rotation in hand feed situations, are taxed to their maximum limits when used to cope small light gauge metal tubing. Such a saw is often used for cutting a tubular hole through a solid section of wood or similar material by means of constant engagement of its teeth with a workpiece, and thus typically has openings in its body to allow the removal of a core of material removed from the workpiece that becomes lodged within the cylindrical body. Such openings make the saw quite flimsy and thus incapable of forming a cope in metal members having significant wall thickness.

As a result, there is a desire for a relatively low-cost tool that can be used to cope sections of hard material with substantial thickness in a relatively short period of time with minimal tool wear.

### SUMMARY OF THE INVENTION

According to a first aspect of the invention there is provided a rotary cutting tool for removing material from a workpiece, said rotary tool comprising:

a cylindrical body having a longitudinal central axis, an annular end face, generally constant inner and outer diameters defining a generally constant wall thickness therebetween and an outer surface that is continuous along substantially an entire length thereof; and

a plurality of teeth operably supported on the cylindrical body at the annular end face thereof, said plurality of teeth being circumferentially spaced about said annular end face, each tooth having a cutting edge thereon disposed substantially longitudinally beyond the annular end face in a direction opposite the cylindrical body;

circumferential spacing of the teeth thereby substantially wholly defining material receiving areas for receiving the material cut from the workpiece between said teeth.

The fluteless continuous construction of the tool allows the wall thickness of the cylindrical body to be kept thin, thereby minimizing the necessary width of material removal to allow the tool to be fed through the workpiece. The relative low cutting width results in correspondingly low cutting forces and heat generation, which results in an improved tool life. The substantially continuous structure of the cylindrical body ensures that the strength of the relatively thin walls is maximized. Due to the lack of flutes for receiving material removed from the workpiece, the teeth are spaced so as to allow the buildup of material between them during cutting.

Preferably the cutting tool is provided in combination with metal working machinery for driving the cutting tool for rotation about the longitudinal central axis thereof.

Preferably the metal working machinery comprises an automatic feed component for feeding the cutting tool along the longitudinal central axis thereof.

Preferably the cutting tool and metal working machinery are provided in combination with the workpiece, said workpiece, metal working machinery and cutting tool being relatively oriented such that each tooth will contact said workpiece during only a portion of driven rotation of said cutting tool by said metal working machinery.

Using the tool for intermittent cutting where the teeth are not in constant contact with the workpiece throughout the tool's rotation allows the material collected between the teeth during cutting to become dislodged during an unobstructed portion of the tool's rotational path. This makes the tool useful in coping metal sections, as the tool can be continuously fed through the workpiece with a relatively low amount of tooth wear.

Preferably the teeth are of greater hardness than the cylindrical body.

Preferably the teeth extend from the end face in a direction opposite the cylindrical body.

Preferably the cutting edge comprises two nonparallel portions defining a bevel therebetween.

Preferably the bevel defined between the two nonparallel portions of the cutting edge is symmetric about a center of the tooth in a radial direction with respect to the cylindrical body.

Symmetric beveled portions increase the effective length of the cutting edge, improve corner strength of the tooth at the cutting edge and encourage even wear over the width of the tooth.

Preferably each tooth is tapered in thickness away from the cutting edge thereof toward the cylindrical body to provide clearance.

Preferably each tooth is tapered in thickness away from the cutting edge thereof toward a trailing edge opposite said cutting edge along the annular end face to provide clearance.

Preferably each tooth is symmetrically tapered about a radial center thereof with respect to the cylindrical body.

Preferably the teeth are thicker than the wall thickness of the cylindrical body and thus protrude radially therefrom.

Preferably the teeth protrude from the cylindrical body both radially inward and outward.

Preferably the cylindrical body comprises unhardened material. This provides the tool with a degree of flexibility to prevent failure should a tooth briefly catch on the workpiece during the tool's rotation.

Preferably the teeth comprise carbide.

Preferably the teeth are replaceable. In this case, the cutting tool may be provided in combination with replacement teeth therefore. Tool life is thus improved not only by reducing cutting forces, but allowing teeth to be replaced after substantial wear to allow continued use of the same tool body.

Preferably the cutting end of the cylindrical body has a plurality of seating recesses extending thereinto in which the teeth are received.

Preferably each seating recess and a respective tooth have mating surfaces engaged to locate said tooth within said recess thereby providing proper tooth alignment with respect to the cylindrical body.

Preferably the mating surfaces of each seating recess and respective tooth comprise mating beveled portions.

Preferably each seating recess and the respective tooth are tapered in width longitudinally away from the annular end face, said width being measured along the annular end face.

Preferably each tooth is attached to the cylindrical body along substantially an entire length of the mating surface of said tooth.

Preferably the teeth are attached to the body by silver solder.

Providing complimentary shaped teeth and recesses allows a user to quickly and easily install replacement teeth in a properly aligned fashion to ensure optimum tool performance after tooth replacement.

Preferably the cylindrical body has gullets recessed thereinto from the annular end face thereof, each gullet disposed adjacent a respective tooth on a side thereof having the cutting edge.

Preferably a portion of the annular end face between adjacent teeth extends in a plane perpendicular to the central axis of the cylindrical body.

Preferably the wall thickness is between 0.080 and 0.120 inches.

Preferably the teeth extend longitudinally beyond the annular end face away from the cylindrical body by between 0.020 and 0.050 inches.

### BRIEF DESCRIPTION OF THE DRAWINGS

In the accompanying drawings, which illustrate an exemplary embodiment of the present invention:

FIG. 1 is an end view of the rotary cutting tool of the present invention having cut through a workpiece.

FIG. 2 is a plan view of the rotary cutting tool of the present invention before cutting through a workpiece.

FIG. 3 is a close up side view of a tooth of the rotary cutting tool of the present invention received in a seating recess of the annular body of the tool.

FIG. 4 is a close up view of a replacement tooth for the rotary cutting tool of the present invention about to be received in a seating recess of the annular body of the tool.

FIG. 5 is an isometric view of a tooth of the rotary cutting tool of the present invention received in a seating recess of the annular body of the tool.

FIG. 6 is an elevational view of the replacement tooth of FIG. 4 as taken from line 6-6 thereof.

### DETAILED DESCRIPTION

As best shown in FIG. 2, the rotary cutting tool 10 of the present invention features a cylindrical body 12, a shank 14 and a plurality of teeth 16. The teeth 16 are disposed in a spaced manner about the circumference of an annular end face 18 of the cylindrical body 12. At a second end 20 opposite the cutting end 18, the shank 14 extends from the cylindrical body 12 in order to support the tool 10 on a drive source 22 which rotates and feeds the tool about and along a central axis 24 thereof. Driven for rotation and fed through a workpiece 26, the teeth 16 cut a narrow swath of material away such that the part of the workpiece around which the tool rotates can be removed, thereby resulting in a cope 28.

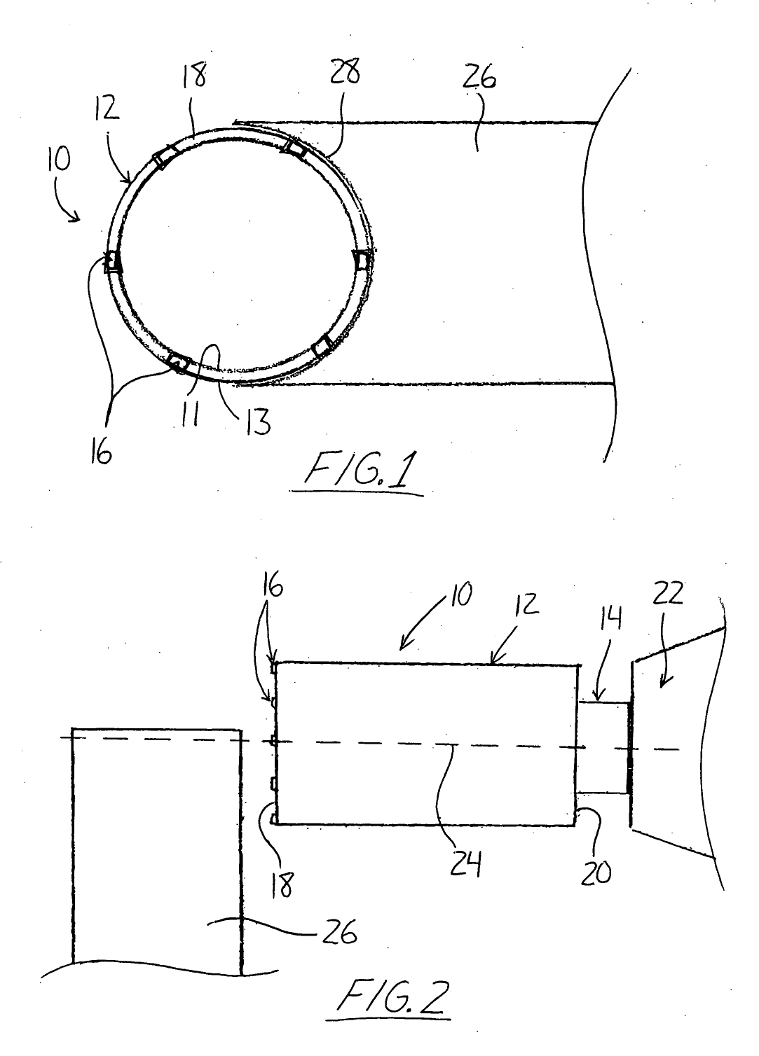

As seen at the cutting end 18 of the tool 10 in FIG. 1, the wall thickness of the cylindrical body 12, as defined by the constant diameters of the inner and outer surfaces 11 and 13, is uniform. In other words, the tool is not fluted like a conventional annular cutter. This allows the wall thickness, and thus the tooth width, to be kept to a minimum, thereby reducing the swath of the cut made by the teeth 16 to create the cope. Removing only a small amount of material from the workpiece 26 keeps the cutting load on the tool 10 to a minimum to reduce heat generation and tool wear. The spaced apart arrangement of the teeth 16 allows material removed from the workpiece to be contained between adjacent teeth until a time at which this material receiving area reaches a portion of the tool's rotation in which it is not enclosed by the workpiece. At this point, material built up between the adjacent teeth is dislodged from the tool to prevent jamming.

It should be appreciated that the cutting tool 10 of the present invention is not suitable for cutting situations where the teeth 16 constantly engage the workpiece 26, as the space between the teeth will become filled with the material removed, eventually causing the tool to jam and cease rotation if the material is not allowed room to be ejected. Instead, the tool is intended for use in coping or other applications wherein at least one portion of the tool's rotational path is not obstructed by the workpiece. If the tool is used in a constant tooth engagement situation, it should only be applied in such a manner for brief periods of time and then removed to allow cut material to escape. In other words, the engagement of any tooth 16 with the workpiece must be intermittent due to the lack of flutes for material escape from the cutting area, which is what keeps the cutting swath of the tool to a minimum. The teeth 16 must be sufficiently spaced apart to allow material to build up between them during a cutting portion of the tool's rotational path.

To create an end cope 28 like that shown in FIG. 1, the workpiece 26, tool 10 and drive source 22 are relatively positioned in a manner similar to that of FIG. 2. The workpiece 26 is positioned such it does not extend across the full diameter of the tool's annular body 12. From the figure, it should be appreciated that when the tool 10 is driven for rotation about its axis 24 by the drive source 22 and fed into the workpiece 26 along the same axis, the teeth 16 mounted on the cutting end 18 will only contact the workpiece 26 during a portion of their rotation. Material removed from the workpiece during this cutting portion of the rotation by the teeth is ejected from the space therebetween during the free portion. In the figure, the central axis 24 of the tool 10 is arranged at a ninety degree angle to a central longitudinal axis of the workpiece 26 to create a cope 28 straight therethrough. It should be appreciated, however, that this angle may be adjusted to create copes anywhere in the range of forty-five to ninety degrees. As such, the cylindrical body 12 is sufficiently long relative to its diameter to allow the tool 10 to cut through a workpiece having the same diameter as the body 12 at angles between forty-five and ninety degrees to the axis of the workpiece. It should also be appreciated that the tool 10 is not limited to end copes nor any particular shape, size or section thickness of the workpiece 26. For example, testing has shown that the tool 10 is capable of forming a cope in a solid steel bar.

In order to reduce the frequency of tool replacement, the tool 10 of the present invention features replaceable teeth 16. Each tooth 16 is received in a respective seating recess 30 that extends into the annular body 12 at the cutting end 18 in a direction generally parallel to the central axis 24. The teeth 16 and seating recesses 30 are shaped such that each tooth completely fills its respective recess when received therein and supports its cutting edge 36 beyond the annular end face 18 in a direction opposite the recess. Mating surfaces 32 and 34 of the tooth 16 and recess 30 respectively are shaped to fit together in a flush manner when the tooth 16 is received in the recess 30. As a result, the tooth 16 must take on a particular orientation about a radial axis in order to become fully seated within the recess 30. This arrangement thereby ensures proper alignment between the tooth 16 and cylindrical body 12 to achieve predetermined rake and clearance angles of a cutting edge 36 and upper edge 38 of the tooth respectively. Portions 42 and 43 of the mating surfaces 32 and 34 respectively are angled with respect to the longitudinal central axis of the cylindrical body 12 such that the tooth 16 and recess 30 taper in width moving into the body 12. This tapering ensures that the tooth initially fits easily into the recess, but the fit between the mating surfaces grows tighter as the tooth 16 is inserted further toward its fully seated position.

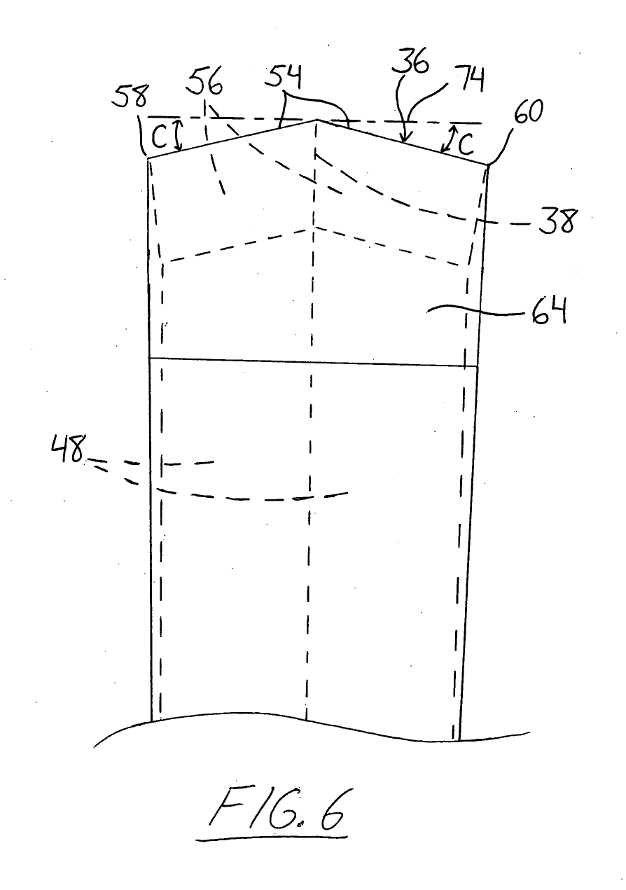

Portions 44 and 46 of the mating surfaces 32 and 34 of the tooth 16 and recess 30 respectively are each beveled to ensure that the proper radial position of the tooth 16 with respect to the annular end face 18 and orientation of the tooth 16 about a longitudinal axis are achieved when the tooth is inserted into the recess 30. This feature is best illustrated in the isometric view of FIG. 5 where it can be seen that the mating surface portion 44 of the tooth 16 is made up of nonparallel surfaces 48 having a bevel therebetween. Similarly, the mating surface portion 46 of the recess 30 is made up of nonparallel surfaces 50 having a bevel therebetween. It should be appreciated that if the mating surfaces 32 and 34 were flat along their entire lengths, that radial positioning of the tooth 16 with respect to the cylindrical body 12 would have to be achieved by eye and feel. Overall, the complimentary shaping of the tooth 16 and recess 30 make the tooth self aligning upon full insertion into the seating recess.

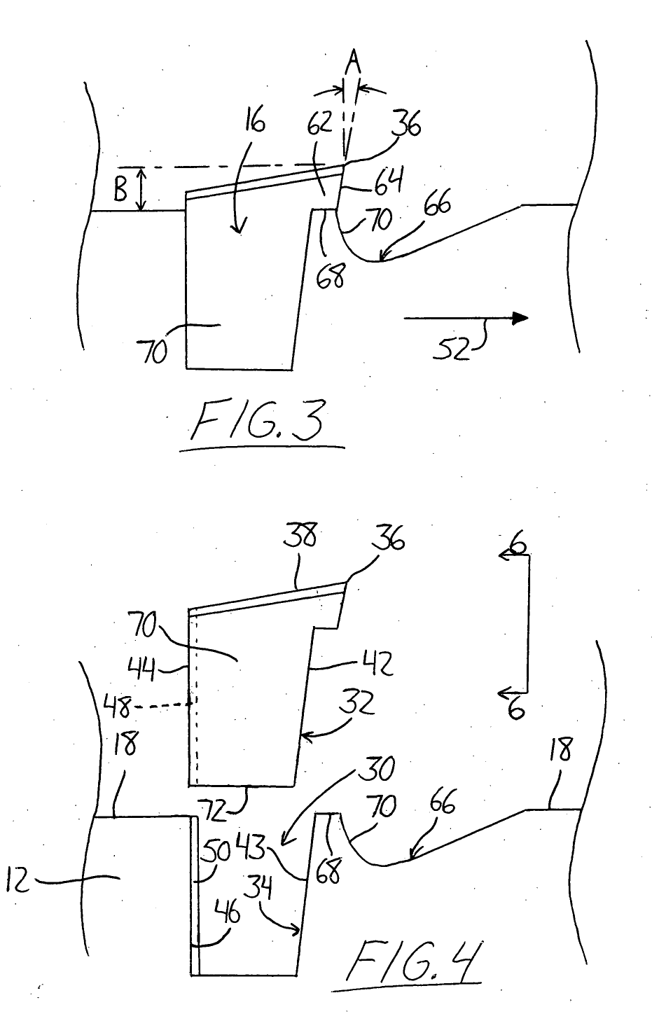

The automatic aligning arrangement provided between the tooth 16 and seating recess 30 allows a user to easily replace teeth as needed while ensuring accurate alignment. Once fully seated in the recess 30, the tooth is secured to the annular body 12 by suitable means known to those of skill in the art, such as by use of silver solder. The tooth 16 should be secured to the body 12 along substantially the entire length of the mating surfaces 32 and 34 in order to ensure maximum resistance to displacement by cutting forces. Particularly, testing has shown that the tooth 16 is firmly attached to the body 12 when secured thereto fully along a trailing side and at least two-thirds the way up a leading side of the seating recess 30. In FIG. 3, the arrow 52 indicates the direction of rotation in order to define the leading and trailing sides of the tooth and recess. It should be appreciated that due to the arcuate motion of the teeth in a rotary tool fed in an axial direction of the body, the forces exerted on the teeth are not as substantially wholly tangential to the body as in a rotary tool fed along a tangential path, such as a circular saw.

It should be appreciated that pairing portions of the mating surfaces 32 and 34 other than 44 and 46 may be similarly beveled in a complimentary manner to facilitate tooth alignment. Also, arrangements other than the symmetric beveling of surfaces about an axis may be used to align the tooth. For example, opposite ones of the tooth and recess could each feature one of a protrusion and groove which slidably engage as the tooth is inserted into the groove.

With the tooth fully seated and supported within the recess 30, the cutting edge 36 is supported spaced longitudinally from the cylindrical body 12 past the annular end face 18 thereof. The direction of rotation of the tool 10 is shown by arrow 52 in FIG. 3 to indicate the position of the cutting edge 36 as being on the leading side of the tooth 16. As shown in FIG. 5, the cutting edge 36 features two nonparallel portions 54 forming a bevel therebetween. These cutting edge portions 54 and the bevel therebetween are defined by upper surfaces 56 which are beveled about upper edge 38 of the tooth 16. The beveled cutting edge 36 increases the effective cutting area over that of a flat cutting edge extending across the same tooth width. From FIG. 6, it should be appreciated that a straight cutting edge extending between its opposite corners 58 and 60 would have a length less than the combined length of beveled cutting edge portions 54, and therefore would remove less material from a workpiece with each rotation of the tool 10. Furthermore, the beveled cutting edge 36 also increases the internal angles of the tooth beyond ninety degrees at its corners 58 and 60, thereby improving the strength thereof. Symmetrically angling the beveled surfaces 56 about the upper edge 38 from a flat arrangement promotes even wearing of the tooth on each side thereof.

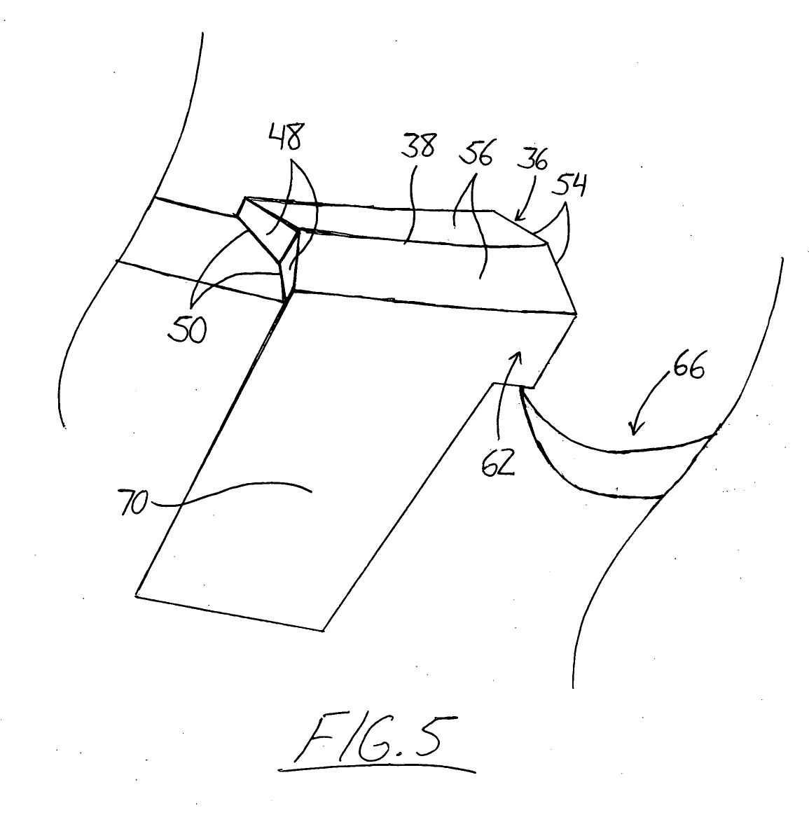

As shown in FIGS. 3 and 4, the cutting edge 36 is defined on an extension portion 62 jutting out from the angled portion 42 of the mating surface 32 on the leading side of the tooth 16. An end face 64 of the extension portion 62, atop of which the cutting edge 36 is disposed, is angled with respect to the longitudinal axis of the tool body 12 in order to create a rake angle A at the cutting edge. A gullet 66 is provided extending longitudinally into the cylindrical body 12 from the annular end face 18 at the end face 64 of the extension portion 62 of each tooth 16. The annular end face 18 of the body 12 defines a ledge 68 upon which the extension portion 62 of the tooth 16 sits to support the cutting edge 36. A trailing edge 70 of extends downward at an angle from the end face 64 of the tooth 16 into the cylindrical body 12. The gullet 66 then slopes back upward toward the end face 18, which extends in a plane perpendicular to the central axis of the body 12 to the next tooth. The angle of the end face 64 of the tooth from the longitudinal axis positions the cutting edge 36 over the gullet 66, specifically the trailing edge 70 thereof past the ledge 68.

As shown in the figures, the gullets 66 extend only a very limited distance into the cylindrical body 12 such that an outer surface thereof remains undisturbed over nearly the full length of the body. These small gullets ensure that the strength of the tool body is not compromised by breaks in the continuity thereof over a substantial majority of its length. While reducing the cutting forces by decreasing the necessary swath width, the relatively low wall thickness of the cylindrical body 12 compared to fluted annular metal cutters also reduces the amount of material providing the tool's strength. As a result, it is important to maintain integrity over the substantial majority of the body 12.

The tooth 16 is made so as to be slightly thicker than the wall thickness of the cylindrical body 12 to prevent jamming of the tool during driven rotation into a workpiece. This additional thickness is kept to a minimum to avoid unnecessary and undesirable increase in cutting forces. As seen in FIG. 6, the tooth 16 is widest between the opposite corners 58 and 60 of the cutting edge 36. From here the tooth tapers in thickness both toward a trailing side thereof and in the longitudinal direction into the cylindrical body 12. The tapering in each direction is symmetrical. The tapering of the tooth 16 and the angle of the upper edge 38 thereof create both radial and longitudinal clearances from a workpiece during removal of material therefrom by the cutting edge 36.

As shown in FIG. 3, the detailed embodiment features a rake angle A of approximately 3 degrees and a 0.050 inch spacing B between the cutting edge and annular end face. The teeth may be sharpened to reduce spacing B to as low as 0.020 inch. The tool is auto-fed in a suitable metal working machine at a rate of approximately 0.005 inches per revolution and operated at approximately 750 surface feet per minute. The teeth are each tapered by 0.005 inch on each side from a maximum thickness of 0.120 inch between the cutting edge corners 58 and 60 to a miniumum thickness of 0.110 inch at the mating surface portion 44 on the trailing side and the bottom of the tooth 72. As shown in FIG. 6, the nonparallel portions 54 of the cutting edge 36 are each tilted downward from a plane 74 parallel to the annular end face 18 of the cylindrical body 12 by an angle C of approximately 12.5 degrees about upper edge 38 at the end face 64 of the tooth 16. It should be appreciated that the above numbers are presented in an exemplary context, and as such, are not intended to limit the scope of the present invention.

The drive source 22 may be any one of a number of machines known to those of skill in the art, including but not limited to milling machines, engine lathes and auto-feed drill presses. The rigid support and automated feed of such a machine prevent unwanted movement of the tool resulting from the intermittent contact between a tooth and the workpiece, resulting in a clean cut. The relatively small rake angle and relatively high protrusion of the teeth from the body of the detailed embodiment are suited for cutting hard materials with such a machine. Coolant may be used in manner known to those of skill in the art when cutting with the present invention. An unhardened 4140 alloy steel construction for the cylindrical body 12 and shaft 14 combined with carbide teeth provides the tool with sufficient flexibility and durability for use as a metal coping tool.

The number of teeth used in the present invention can be varied. The tool has been found to retain its ability to cope metal sections with only one tooth left on the body. The number of teeth can be increased so long as sufficient spacing is left between them for containing material removed from the workpiece until it can be dislodged from the spacing during an unobstructed portion of the tool's rotational path. For example, knowing the amount of material removed by a particular design of tooth in a distance corresponding to one rotation of the tool and sizing the inter-tooth spacing to adequately contain that amount would ensure that the tool would function properly without jamming when used in the type of intermittent cutting where the tooth is free of contact with the workpiece for a portion of the tool's rotational path.

Since various modifications can be made in my invention as herein above described, and many apparently widely different embodiments of same made within the spirit and scope of the claims without department from such spirit and scope, it is intended that all matter contained in the accompanying specification shall be interpreted as illustrative only and not in a limiting sense.

1. A rotary cutting tool for removing material from a workpiece, said rotary tool comprising:
a cylindrical body having a longitudinal central axis, an annular end face, generally constant inner and outer diameters defining a generally constant wall thickness therebetween and an outer surface that is continuous along substantially an entire length thereof; and
a plurality of teeth operably supported on the cylindrical body at the annular end face thereof, said plurality of teeth being circumferentially spaced about said annular end face, each tooth having a cutting edge thereon disposed substantially longitudinally beyond the annular end face in a direction opposite the cylindrical body;
circumferential spacing of the teeth thereby substantially wholly defining material receiving areas for receiving the material cut from the workpiece between said teeth.

2. The cutting tool according to claim 1 in combination with metal working machinery for driving the cutting tool for rotation about the longitudinal central axis thereof.

3. The cutting tool according to claim 2 wherein the metal working machinery comprises an automatic feed component for feeding the cutting tool along the longitudinal central axis thereof.

4. The cutting tool according to claim 2 in combination with the workpiece, said workpiece, metal working machinery and cutting tool being relatively oriented such that each tooth will contact said workpiece during only a portion of driven rotation of said cutting tool by said metal working machinery.

5. The cutting tool according to claim 1 wherein the teeth are of greater hardness than the cylindrical body.

6. The cutting tool according to claim 1 wherein the cutting edge comprises two nonparallel portions defining a bevel therebetween.

7. The cutting tool according to claim 1 wherein each tooth is tapered in thickness away from the cutting edge thereof toward the cylindrical body to provide clearance.

8. The cutting tool according to claim 1 wherein each tooth is tapered in thickness away from the cutting edge thereof toward a trailing edge opposite said cutting edge along the annular end face to provide clearance.

9. The cutting tool according to claim 1 wherein the teeth are thicker than the wall thickness of the cylindrical body and thus protrude radially therefrom.

10. The cutting tool according to claim 1 wherein the cylindrical body comprises unhardened material.

11. The cutting tool according to claim 1 wherein the teeth comprise carbide.

12. The cutting tool according to claim 1 wherein the teeth are replaceable.

13. The cutting tool according to claim 1 wherein the cutting end of the cylindrical body has a plurality of seating recesses extending thereinto in which the teeth are received.

14. The cutting tool according to claim 14 wherein each seating recess and a respective tooth have mating surfaces engaged to locate said tooth within said recess thereby providing proper tooth alignment with respect to the cylindrical body.

15. The cutting tool according to claim 14 wherein the mating surfaces of each seating recess and respective tooth comprise mating beveled portions.

16. The cutting tool according to claim 13 wherein each seating recess and the respective tooth are tapered in width longitudinally away from the annular end face, said width being measured along the annular end face.

17. The cutting tool according to claim 14 wherein each tooth is attached to the cylindrical body along substantially an entire length of the mating surface of said tooth.

18. The cutting tool according to claim 17 wherein the teeth are attached to the body by silver solder.

19. The cutting tool according to claim 1 wherein the cylindrical body has gullets recessed thereinto from the annular end face thereof, each gullet disposed adjacent a respective tooth on a side thereof having the cutting edge.

20. The cutting tool according to claim 19 wherein a portion of the annular end face between adjacent teeth extends in a plane perpendicular to the central axis of the cylindrical body.
